(19) United States
(12) Patent Application Publication
(10) Pub. No.: US 2025/0024358 A1
(43) Pub. Date: Jan. 16, 2025

(54) APPARATUS AND METHOD FOR MANAGING TERMINAL CONFIGURATION INFORMATION IN WIRELESS COMMUNICATION SYSTEM

(71) Applicant: Samsung Electronics Co., Ltd., Suwon-si (KR)

(72) Inventors: Hoyeon LEE, Suwon-si (KR); Dongeun SUH, Suwon-si (KR)

(21) Appl. No.: 18/768,469

(22) Filed: Jul. 10, 2024

(30) Foreign Application Priority Data
Jul. 12, 2023 (KR) 10-2023-0090649
Aug. 10, 2023 (KR) 10-2023-0105004

(51) Int. Cl. H04W 48/18; H04W 48/16; H04W 60/00

(52) U.S. Cl. CPC H04W 48/18; H04W 48/16; H04W 60/00

(57) ABSTRACT

The disclosure relates to a fifth generation (5G) or sixth generation (6G) communication system for supporting a higher data transmission rate. A method performed by an access and mobility management function (AMF) in a wireless communication system is provided. The method includes receiving, from a user equipment (UE), a requested network slice selection assistance information (NSSAI), receiving, from a unified data management (UDM), a subscribed single-NSSAI (S-NSSAI), determining whether an S-NSSAI in the requested NSSAI is either the subscribed S-NSSAI or an alternative S-NSSAI in a UE context, and determining whether to update the UE configuration in case that the S-NSSAI in the requested NSSAI is neither the subscribed S-NSSAI nor the alternative S-NSSAI in the UE context.

### CROSS-REFERENCE TO RELATED APPLICATION(S)

This application is based on and claims priority under 35 U.S.C. § 119 (a) of a Korean patent application number 10-2023-0090649, filed on Jul. 12, 2023, in the Korean Intellectual Property Office, and of a Korean patent application number 10-2023-0105004, filed on Aug. 10, 2023, in the Korean Intellectual Property Office, the disclosure of each of which is incorporated by reference herein in its entirety.

### BACKGROUND

### 1. Field

The disclosure relates to a wireless communication system. More particularly, the disclosure relates to an apparatus and method for managing terminal configuration information in a wireless communication system.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHZ, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 terahertz (THz) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low-latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of band-width part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol 014 technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for managing terminal configuration information in a wireless communication system.

Additional aspects will be set forth in part in the description which follows and, in part, will be apparent from the description, or may be learned by practice of the presented embodiments.

In accordance with an aspect of the disclosure, a method performed by an access and mobility management function (AMF) in a wireless communication system is provided. The method includes receiving, from a user equipment (UE), a requested network slice selection assistance information (NSSAI), receiving, from a unified data management (UDM), a subscribed single-NSSAI (S-NSSAI), determining whether an S-NSSAI in the requested NSSAI is either the subscribed S-NSSAI or an alternative S-NSSAI in a UE context, and determining whether to update a UE configuration in case that the S-NSSAI in the requested NSSAI is neither the subscribed S-NSSAI nor the alternative S-NSSAI in the UE context.

In an embodiment of the disclosure, the method further includes storing information on mapping of the S-NSSAI to the alternative S-NSSAI in the UE context.

In an embodiment of the disclosure, the method further includes transmitting, to the UE, a UE configuration update message for updating a UE configuration based on the determination.

In an embodiment of the disclosure, the method further includes transmitting, to the UE, a message including information on mapping of the S-NSSAI to the Alternative S-NSSAI to the UE, in case that the S-NSSAI in the requested NSSAI is the alternative S-NSSAI in the UE context, wherein the message is a UE configuration update message or a registration accept message.

In an embodiment of the disclosure, the method further includes transmitting, to the UE, a registration accept message including an allow NSSAI in case that in case that the S-NSSAI in the requested NSSAI is either the subscribed S-NSSAI or an alternative S-NSSAI in the UE context.

In accordance with another aspect of the disclosure, a method performed by a user equipment (UE) in a wireless communication system is provided. The method includes transmitting, to an access and mobility management function (AMF), a requested network slice selection assistance information (NSSAI), wherein a subscribed single-NSSAI (S-NSSAI) is transmitted from a unified data management (UDM) to the AMF, wherein whether an S-NSSAI in the requested NSSAI is either the subscribed S-NSSAI or an alternative S-NSSAI in a UE context is determined, and wherein whether to update a UE configuration is determined in case that the S-NSSAI in the requested NSSAI is neither subscribed S-NSSAI nor Alternative S-NSSAI in the UE context.

In accordance with another aspect of the disclosure, an access and mobility management function (AMF) in a wireless communication system is provided. The AMF includes a transceiver, and a controller operably connected to the transceiver, the controller configured to receive, from a user equipment (UE), a requested network slice selection assistance information (NSSAI), receive, from a unified data management (UDM), a subscribed single-NSSAI (S-NSSAI), determine whether an S-NSSAI in the requested NSSAI is either the subscribed S-NSSAI or an alternative S-NSSAI in a UE context, and determine whether to update a UE configuration in case that the S-NSSAI in the requested NSSAI is neither the subscribed S-NSSAI nor the alternative S-NSSAI in the UE context.

In accordance with another aspect of the disclosure, a user equipment (UE) in a wireless communication system is provided. The UE includes a transceiver, and a controller operably connected to the transceiver, the controller configured to transmit, to an access and mobility management function (AMF), a requested network slice selection assistance information (NSSAI), wherein a subscribed single-NSSAI (S-NSSAI) is transmitted from a unified data management (UDM) to the AMF, wherein whether an S-NSSAI in the requested NSSAI is either the subscribed S-NSSAI or an alternative S-NSSAI in a UE context is determined, and wherein whether to update a UE configuration is determined in case that the S-NSSAI in the requested NSSAI is neither subscribed S-NSSAI nor Alternative S-NSSAI in the UE context.

According to an embodiment of the disclosure, terminal configuration information can be managed more efficiently in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a configuration of S-NSSAI IE according to an embodiment of the disclosure;

FIG. 2 is a diagram illustrating an architecture of a mobile communication system according to an embodiment of the disclosure;

FIG. 3 is a diagram illustrating a procedure for exchanging alternative slice information in a wireless communication system according to an embodiment of the disclosure;

FIG. 4 is a diagram illustrating a procedure for determining and managing alternative slice information during a registration procedure in a wireless communication system according to an embodiment of the disclosure;

FIG. 5 is a diagram illustrating a procedure for determining and managing information on an alternative slice using a terminal configuration update procedure in a wireless communication system according to an embodiment of the disclosure;

FIG. 6 is a diagram illustrating a procedure for reconfiguring existing slice information to a terminal using a terminal configuration update procedure in a wireless communication system according to an embodiment of the disclosure;

FIG. 7 is a diagram illustrating a procedure for reconfiguring existing slice information to a terminal using a terminal configuration update procedure in a wireless communication system according to an embodiment of the disclosure;

FIG. 8 is a diagram illustrating a procedure for updating terminal configuration information during a registration procedure in a wireless communication system according to an embodiment of the disclosure;

FIG. 9 is a diagram illustrating a new protocol data unit (PDU) session establishment procedure in a wireless communication system according to an embodiment of the disclosure;

FIG. 10 is a diagram illustrating a structure of a terminal according to an embodiment of the disclosure; and

FIG. 11 is a diagram illustrating a structure of a network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, the disclosure relates to an apparatus and method for providing a network slice in a wireless communication system. In particular, the disclosure relates to a technology of controlling and managing a terminal configuration information in a mobile communication network system providing a network slice function in the wireless communication system.

In the third generation partnership project (3GPP) standards, 5G network system architectures and procedures are standardized. A mobile communication network operator may provide various services in a 5G network. In order to provide each service, the mobile communication network operator may have to satisfy different service requirements (e.g., latency, communication range, data rate, bandwidth, reliability, or the like). To this end, the mobile communication network operator may configure network slices, and may allocate an appropriate network resource for a particular service according to each of the network slices or according to a set of a network slice. The network resource may indicate a network function (NF), a logical resource provided by the NF, or radio resource allocation by a base station (BS).

For example, the mobile communication network operator may configure a network slice A to provide a mobile broadband service, may configure a network slice B to provide a vehicle communication service, and may configure a network slice C to provide an Internet of things (IOT) service. For example, in the 5G network, each service may be provided on a dedicated network slice according to features of each service. As a differentiator for differentiating network slices, single-network slice selection assistance information (S-NSSAI) defined in the 3GPP may be used.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™M chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

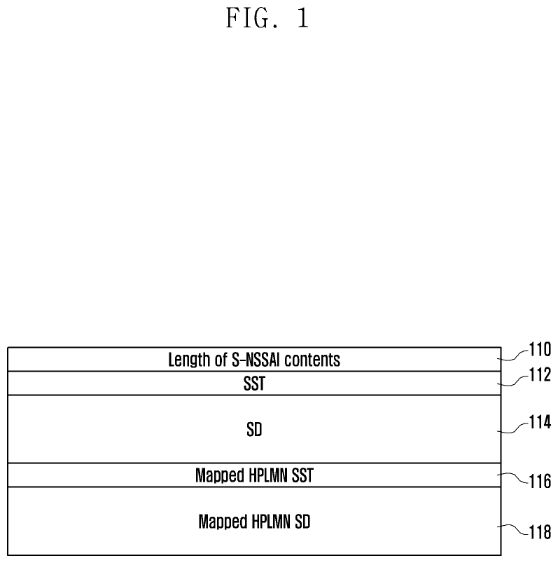

FIG. 1 is a diagram illustrating a configuration of an S-NSSAI information element (IE) according to an embodiment of the disclosure.

Referring to FIG. 1, one S-NSSAI may include at least one of a slice/service type (SST) 116 used in a home public land mobile network (Home PLMN or HPLMN), a slice differentiator (SD) 118 used in the HPLMN, an SST 112 used in a serving PLMN, and an SD 114 used in the serving PLMN.

In a non-roaming situation, the SST 112 used in the serving PLMN may be the SST 116 used in the HPLMN, and the SD 114 used in the serving PLMN may be the SD 118 used in the HPLMN.

In a roaming situation, the SST 112 used in the serving PLMN may be an SST used in a visited PLMN (VPLMN), and the SD 114 used in the serving PLMN may be an SD used in the VPLMN.

Each of SSTs and each of SDs configuring one S-NSSAI may have a value or a null value according to a situation.

Network slice selection assistance information (NSSAI) may include one or more pieces of S-NSSAI. An example of NSSAI may include configured NSSAI stored in a UE, requested NSSAI requested by the UE, Allowed NSSAI allowed for use by the UE determined by an NF (e.g., AMF, NSSF, or the like) of a 5G core network, subscribed NSSAI to which the UE subscribes, and the like, but this is merely exemplary and the example of NSSAI is not limited thereto.

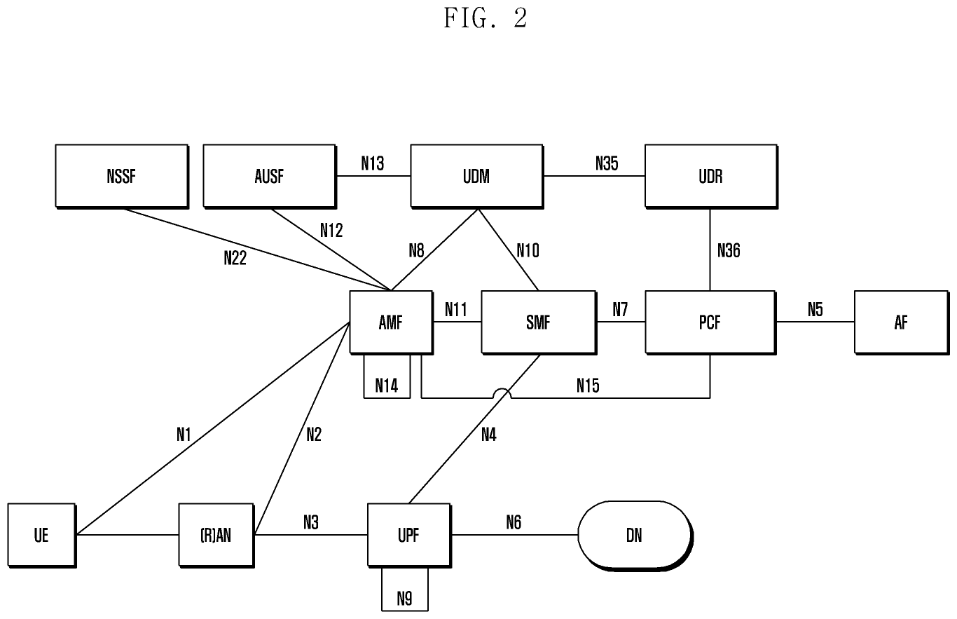

FIG. 2 is a diagram illustrating architecture of a mobile communication system according to an embodiment of the disclosure.

Referring to FIG. 2, the 5G System (5GS) may include a terminal (UE), a new radio (NR) base station (NG-RAN), and a 5G core network. Referring to FIG. 2, the 5G core network may include access and mobility management function (AMF), session management function (SMF), user plane function (UPF), policy control function (PCF), unified data management (UDM), network slice selection function (NSSF), authentication server function (AUSF), unified data repository (UDR), and the like. The terminal (UE) may access the 5G core network through the base station ((R) AN). Hereinafter, UE may be referred to as a terminal, and (R) AN may be referred to as a base station. Additionally, the 5G core network may further include an Application Function (AF) and a Data Network (DN).

In an embodiment of the disclosure, the AMF is a network function (NF) that manages wireless network access and mobility with respect to the UE.

The SMF is an NF that manages a session with respect to the UE, and session information includes Quality of Service (QOS) information, charging information, packet processing information, or the like.

The UPF is an NF that processes user traffic (e.g., user plane traffic) and is controlled by the SMF.

The PCF is an NF that manages an operator policy (i.e., a PLMN policy) for providing a service in a wireless communication system. In addition, the PCF may be divided into a PCF that manages an access and mobility (AM) policy and a UE policy, and a PCF that manages a session management (SM) policy. The PCF managing the AM/UE policies and the PCF managing the SM policy may be NFs that are logically or physically separate from each other or may be logically or physically one NF.

The UDM is an NF that stores and manages UE subscription information.

The UDR is an NF or a database (DB) that stores and manages data. The UDR may store UE subscription information and may provide the UE subscription information to the UDM. In addition, the UDR may store operator policy information and may provide the operator policy information to the PCF.

The NSSF may be an NF that performs a function of selecting network slice instances for servicing the UE or a function of determining Network Slice Selection Assistance Information (NSSAI).

The AUSF may be an NF that performs a function of supporting authentication for 3GPP access and non-3GPP access.

The AF may be an NF that provides a function for a service according to an embodiment of the disclosure.

A DN may denote a data network capable of providing an operator service, an internet access, a 3rd party service, or the like.

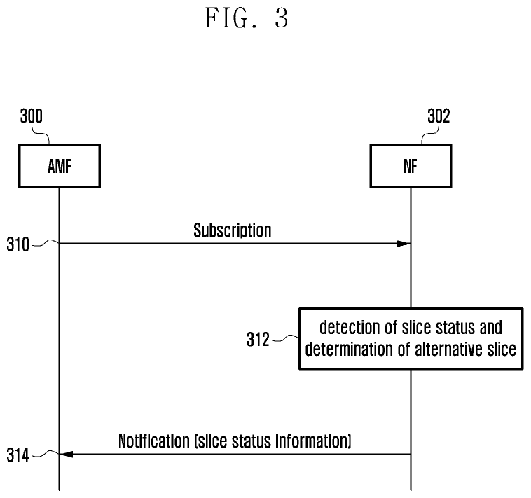

FIG. 3 is a diagram illustrating a procedure for exchanging alternative slice information in a wireless communication system according to an embodiment of the disclosure. Specifically, an NF 302 may be one of the NFs illustrated in FIG. 2 (e.g., NSSF, PCF).

Referring to FIG. 3, in operation 310, an AMF 300 may transmit a subscription message to the NF 302 to receive network slice state information when an event related to the network slice state information occurs. The subscription message may include one or more S-NSSAI information. The S-NSSAI information included in the subscription message may be slice information supported by the AMF.

In operation 312, the NF 302 may monitor the slice status. For example, the NF 302 may detect that a specific slice (first S-NSSAI) is currently unavailable or congested. The NF 302 may determine an alternative S-NSSAI (second S-NSSAI) to replace the unavailable/congested first S-NSSAI. The NF 302 may determine the AMF subscribed to the slice status monitoring event of the first S-NSSAI. In case that the AMF 300 requests the status monitoring for the first S-NSSAI in operation 310, the NF 302 may determine to notify the AMF of the first S-NSSAI status information, configures a notification message, and transmit the notification message in operation 314.

In operation 314, the NF may transmit the notification message to the AMF. The notification message may include status information related to network slice. For example, at least one of the first S-NSSAI that is unavailable or congested and the second S-NSSAI that replaces the first S-NSSAI may be included. Alternatively, information indicating that a third S-NSSAI, which has been unavailable or congested, is available again may be included.

The AMF may determine that the first S-NSSAI is currently unavailable or congested based on at least one of the notification message received in operation 314, information received from the OAM, and local configuration information stored in the AMF. In addition, the AMF may determine alternative slice information to replace the first S-NSSAI, that is, the second S-NSSAI, based on at least one of the notification message received in operation 314, information received from the OAM, and local configuration information stored in the AMF.

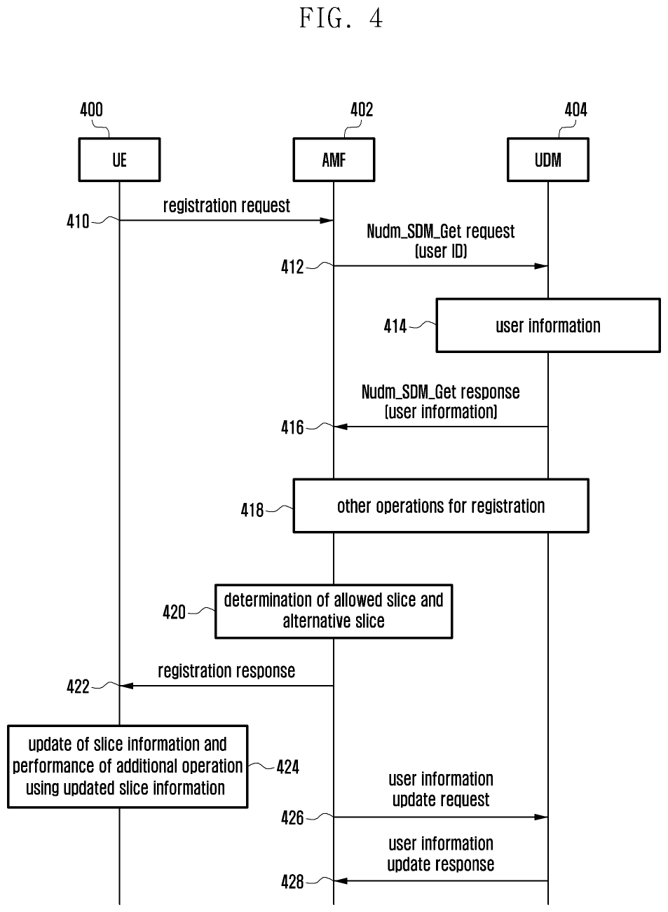

FIG. 4 is a diagram illustrating a procedure for determining and managing alternative slice information during a registration procedure in a wireless communication system according to an embodiment of the disclosure.

Referring to FIG. 4, in operation 410, a UE 400 may perform a registration procedure.

In operation 410, the UE 400 may transmit a registration request message to an AMF 402. The registration request message may include requested slice information (Requested NSSAI) that the UE intends to use. In case that the UE supports a network slice replacement function, the registration request message may include information indicating that the UE supports the network slice replacement function.

In operation 412, the AMF 402 may process a registration request for the UE. A request message for receiving subscription information from an UDM 404 may be transmitted to the UDM 404. The request message may be a Nudm_SDM_Get request message and may include the identity of the UE (subscriber) 400.

In operation 414, the UDM 404 may generate a response including subscription information of the UE (subscriber) according to the request of the AMF 402. A response message including UE subscription information may include subscription slice (Subscribed S-NSSAI) information of the UE.

In operation 416, the UDM 404 may transmit a message responding to the subscription information of the UE (subscriber) to the AMF 402. The message used in this case may be the Nudm_SDM_Get response message.

In operation 418, other operations for registration may be performed.

In operation 420, the AMF 402 may determine allowed slices and alternative slices. The AMF may determine the allowed NSSAI based on the Requested NSSAI received in operation 410 and the subscribed S-NSSAIs received in operation 416.

In operation 420, the AMF 402 may determine whether one or more S-NSSAI (first S-NSSAI) included in the allowed NSSAI is available (unavailable or congested). The AMF 402 may determine whether the first S-NSSAI included in the allowed NSSAI is currently unavailable or congested based on at least one of the notification message received in operation 314, information received from the OAM, and configuration information (local configuration) stored in the AMF.

In operation 420, the AMF 402 may determine an alternative slice (Alternative S-NSSAI) (second S-NSSAI) to replace the unavailable first S-NSSAI based on whether the network slice replacement of the UE received from the UE in operation 410 is supported and the operator policy (local policy). For example, the operator policy may determine an alternative slice only for S-NSSAI for which the UE has established a protocol data unit (PDU) session. Alternatively, the operator policy may determine an alternative slice regardless of whether the UE establishes a PDU session, that is, even for S-NSSAI in which the UE does not establish a PDU session. In case that the AMF determines the determination for the alternative slice (Alternative S-NSSAI) (second S-NSSAI) to replace the unavailable first S-NSSAI, the AMF may determine the alternative slice information to replace the first S-NSSAI, that is, the second S-NSSAI, based on at least one of the notification message received in operation 314, information received from the OAM, and configuration information (local configuration) stored in the AMF. In this case, the first S-NSSAI may be the UE's subscribed slice (Subscribed S-NSSAI). The subscribed S-NSSAI is stored in the UDM 404 and may be one of the S-NSSAIs included in the message received by the AMF 402 in operation 416. Additionally, the second S-NSSAI may or may not be the subscribed S-NSSAI of the UE. The AMF 402 may configure alternative slice mapping information (mapping information of the first S-NSSAI and the second S-NSSAI), that is, alternative slice (Alternative NSSAI). Table 1 below shows an example of alternative NSSAI. For example, Alternative NSSAI may include one or more Entries.

TABLE 1
Alternative NSSAI information element

| | | | | | | | |
|---|---|---|---|---|---|---|---|
| 8 | 7 | 6 | 5 | 4 | 3 | 2 | 1 |

| Alternative NSSAI IEI | octet 1 |
|---|---|
| Length of Alternative NSSAI contents | octet 2 |
| Entry 1 | octet 3* |
| | octet a* |
| Entry 2 | octet a + 1* |
| | octet b* |
| . . . | octet b + 1* |
| | octet c* |
| Entry n | octet c + 1* |
| | octet d* |

Table 2 below shows an example of Entry. For example, each Entry may include one S-NSSAI (first S-NSSAI) and Alternative S-NSSAI (second S-NSSAI) information to be used in place of the S-NSSAI.

TABLE 2
Entry

| | | | | | | | |
|---|---|---|---|---|---|---|---|
| 8 | 7 | 6 | 5 | 4 | 3 | 2 | 1 |

| S-NSSAI to be replaced | octet 3 |
|---|---|
| | octet x |
| Alternative S-NSSAI | octet x + 1 |
| | octet a |

The AMF 402 may include Alternative S-NSSAI (second S-NSSAI) in Allowed NSSAI to use Alternative S-NSSAI (second S-NSSAI). For example, Allowed NSSAI may include both the first S-NSSAI and the second S-NSSAI. Additionally, the AMF 402 may include Alternative NSSAI (mapping information between the first S-NSSAI and the second S-NSSAI) in the Allowed NSSAI of the UE.

The AMF 402 may identify whether the second S-NSSAI is included in the UE's configured NSSAI. In case that the second S-NSSAI is not included in the UE's current configured NSSAI (first configured NSSAI), the AMF 402 may include the second S-NSSAI in the configured NSSAI (second configured NSSAI). Additionally, the AMF 402 may include alternative NSSAI (mapping information between the first S-NSSAI and the second S-NSSAI) in the configured NSSAI of the UE.

The AMF 402 may configure a registration response message including the Allowed NSSAI determined in operation 420. Additionally, the registration response message may include a second configured NSSAI. The registration response message may include alternative NSSAI (mapping information between the first S-NSSAI and the second S-NSSAI).

The AMF 402 may store information related to alternative network slices. The information related to alternative network slices is provided below:
At least one of an indicator indicating whether alternative S-NSSAI is being used, Allowed NSSAI, second S-NSSAI, and mapping information between the first S-NSSAI and the second S-NSSAI (Alternative NSSAI),
In case that there is a PDU session established with the first S-NSSAI or second S-NSSAI, PDU session information (e.g., PDU Session ID, or the like) established with the first S-NSSAI or second S-NSSAI,
In case that the AMF configures the second configured NSSAI, at least one of an indicator indicating whether the configured NSSAI includes an alternative S-NSSAI, and second configured NSSAI.

The AMF 402 may store the information related to alternative network slice in the UE context related to the UE. Alternatively, the AMF may store the information related to alternative network slice in the UDM 404 or UDR. The AMF 402 may perform operations 426 to 428 to store the information related to alternative network slice in the UDM 404 or UDR. In operation 426, the AMF 402 may transmit a message to the UDM 404. The message may include information related to alternative network slice. The UDM 404 may store the received information related to alternative network slice in the UDR.

In operation 422, the AMF 402 may transmit a registration response message to the UE 400. The message may include at least one of allowed NSSAI, configured NSSAI, and alternative NSSAI (alternative slice mapping information) determined by the AMF 402 in operation 420.

In operation 424, the UE 400 may store the slice information received from the AMF 402 and perform additional operations.

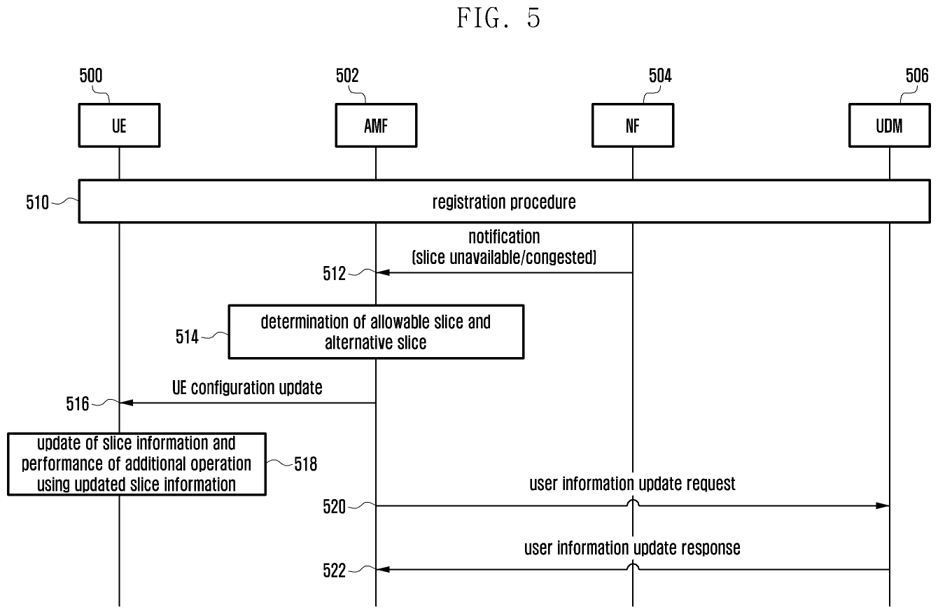

FIG. 5 is a diagram illustrating a procedure for determining and managing information on an alternative slice using a UE configuration update procedure in a wireless communication system according to an embodiment of the disclosure.

Referring to FIG. 5, in operation 510, a UE 500 and an AMF 502 may perform a UE registration procedure. The AMF 502 may determine the first Allowed NSSAI available to the UE during the registration process and transmit the first Allowed NSSAI to the UE 500. The UE may store the first Allowed NSSAI.

In operation 512, an NF 504 may transmit a notification message to the AMF 502. The notification message may include at least one of the first S-NSSAI that is unavailable or congested and the second S-NSSAI that may replace the first S-NSSAI. The operation 512 may correspond to the operation 314 in FIG. 3.

The AMF 502 may determine that the first S-NSSAI is currently unavailable or congested based on at least one of the notification message received in operation 512, information received from the OAM, and configuration information (local configuration) stored in the AMF. In addition, the AMF 502 may determine alternative slice information to replace the first S-NSSAI, that is, the second S-NSSAI, based on at least one of the notification message received in operation 512, information received from the OAM, and configuration information (local configuration) stored in the AMF.

In operation 514, the AMF 502 may determine allowable slices and alternative slices. The AMF 502 may determine whether one or more S-NSSAIs (first S-NSSAI) included in the first Allowed NSSAI determined in operation 510 are available (unavailable or congested). The AMF may determine whether the first S-NSSAI included in the first Allowed NSSAI is currently unavailable or is congested based on at least one of the notification message received in operation 512, information received from the OAM, and configuration information (local configuration) stored in the AMF.

In operation 514, the AMF 502 may determine an alternative slice (alternative S-NSSAI) (second S-NSSAI) to replace the unavailable first S-NSSAI based on whether the UE supports Network Slice Replacement and the operator's policy (local policy). For example, the operator policy may determine an alternative slice only for the S-NSSAI for which the UE has established a PDU session. Alternatively, the operator policy may determine an alternative slice regardless of whether the UE establishes a PDU session, that is, even for S-NSSAI in which the UE does not establish a PDU session. In case that the AMF determines the alternative slice (alternative S-NSSAI) (second S-NSSAI) to replace the unavailable first S-NSSAI, the AMF 502 may determine the alternative slice information to replace the first S-NSSAI, that is, the second S-NSSAI, based on at least one of the notification message received in operation 512, information received from the OAM, and configuration information (local configuration) stored in the AMF. In this case, the first S-NSSAI may be the subscribed S-NSSAI of the UE. Subscribed S-NSSAI may be one of the S-NSSAIs stored in a UDM 506. Additionally, the second S-NSSAI may or may not be the subscribed S-NSSAI of the UE. The AMF 502 may configure alternative slice mapping information (mapping information of the first S-NSSAI and the second S-NSSAI, Alternative NSSAI).

The AMF 502 may identify whether the second S-NSSAI is included in the UE's configured NSSAI. In case that the second S-NSSAI is not included in the UE's current configured NSSAI (first configured NSSAI), the AMF may include at least one of the second S-NSSAI and the mapping information (alternative NSSAI) between the first S-NSSAI and the second S-NSSAI in the configured NSSAI (second configured NSSAI).

The AMF 502 may determine the second Allowed NSSAI including the second S-NSSAI to replace the first S-NSSAI included in the first allowed NSSAI. The second allowed NSSAI may include the first S-NSSAI and the second S-NSSAI. Additionally, the second Allowed NSSAI may include the mapping information (Alternative NSSAI) between the first S-NSSAI and the second S-NSSAI.

The AMF 502 may store information related to alternative network slices. The information related to alternative network slices is provided below:
At least one of an indicator indicating whether alternative S-NSSAI is being used, allowed NSSAI, second S-NSSAI, and mapping information (alternative NSSAI) between the first S-NSSAI and the second S-NSSAI,
In case that there is a PDU session established with the first S-NSSAI or second S-NSSAI, PDU session information (e.g., PDU Session ID, or the like) established with the first S-NSSAI or second S-NSSAI,
In case that the AMF configures the second configured NSSAI, at least one of an indicator indicating whether the configured NSSAI includes an alternative S-NSSAI, and the second configured NSSAI.

The AMF 502 may store the information related to alternative network slices in the UE context related to the UE. Alternatively, the AMF 502 may store the information related to alternative network slices in the UDM 506 or UDR. The AMF may perform operations 520 to 522 to store the information related to alternative network slices in the UDM 506 or UDR. In operation 520, the AMF 502 may transmit a message to the UDM 506. The message may include the information related to alternative network slices. The UDM 506 may store the received information related to alternative network slices in the UDR.

In operation 516, the AMF 502 may transmit a UE configuration update message to the UE 500. The message may include at least one of the second allowed NSSAI, second configured NSSAI, and alternative NSSAI (alternative slice mapping information) determined by the AMF 502 in operation 514.

In operation 518, the UE 500 may store the slice information received from the AMF 502 and perform additional operations.

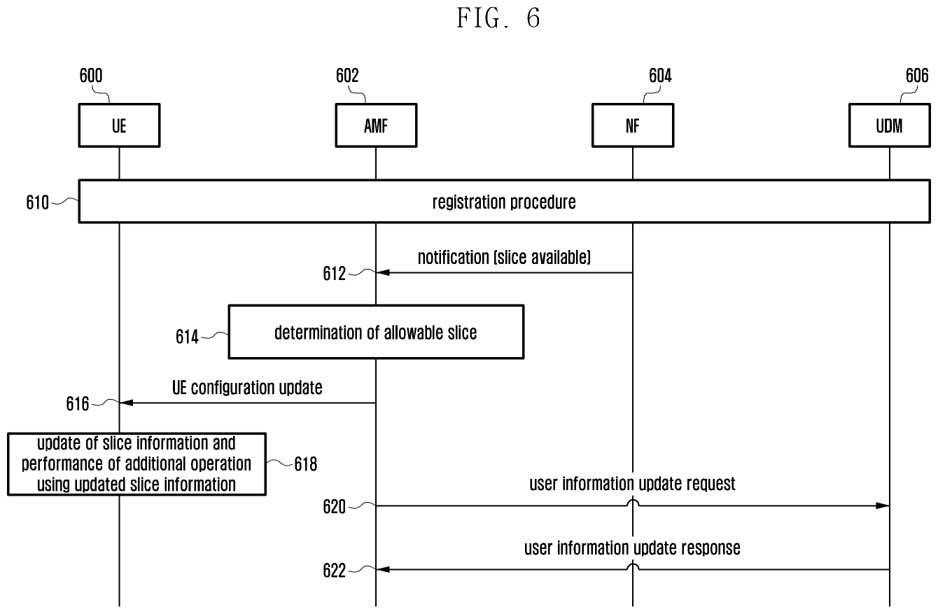

FIG. 6 is a diagram illustrating a procedure for reconfiguring existing slice information to a UE using a UE configuration update procedure in a wireless communication system according to an embodiment of the disclosure.

Referring to FIG. 6, in operation 610, a UE 600 and an AMF 602 may perform a UE registration procedure. In operation 610, the first S-NSSAI that the UE intends to use may be unavailable or congested. Accordingly, the AMF 602 may determine the second S-NSSAI, which is an alternative S-NSSAI to replace the first S-NSSAI, as the method illustrated in FIG. 4. During the registration procedure, the available first allowed NSSAI, first configured NSSAI, and alternative NSSAI (alternative slice mapping information (mapping information of the first S-NSSAI and second S-NSSAI)) may be determined and transmitted to the UE 600. The first Allowed NSSAI may include at least one of the first S-NSSAI, second S-NSSAI, and alternative NSSAI (alternative slice mapping information). The first configured NSSAI may include at least one of the first S-NSSAI, second S-NSSAI, and alternative NSSAI (alternative slice mapping information). During the registration process, the AMF may transmit at least one of allowed NSSAI, configured NSSAI, and Alternative NSSAI to the UE. The UE may store the received slice information.

In operation 612, an NF 604 may transmit a notification message to the AMF 602. The notification message may include information indicating that the first S-NSSAI that has been unavailable or congested is available again. Operation 612 may correspond to the operation 314 in FIG. 3.

The AMF 602 may determine that the first S-NSSAI is currently available based on at least one of the notification message received in operation 612, information received from the OAM, and configuration information (local configuration) stored in the AMF.

The AMF 602 may know that the second S-NSSAI is being used instead of the first S-NSSAI based on at least one of the notification message received in operation 612, information received from OAM, configuration information (local configuration) stored in the AMF, UE context stored in the AMF, and information received from the UDM/UDR.

In operation 614, the AMF 602 may determine allowable slices. The AMF 602 includes the second S-NSSAI, which is an alternative S-NSSAI, instead of the first Allowed NSSAI, which is unavailable or congested, as determined in operation 610, and since the first S-NSSAI is currently available, the second Allowed NSSAI may be configured to include the first S-NSSAI. The second Allowed NSSAI may not include the second S-NSSAI.

The AMF 602 may identify whether the second S-NSSAI is included in the UE's configured NSSAI. In case that the second S-NSSAI is included in the UE's current configured NSSAI (first configured NSSAI), the first S-NSSAI is currently available, so the second configured NSSAI may be configured to include the first S-NSSAI. The second configured NSSAI may not include the second S-NSSAI.

The AMF 602 may update information related to alternative network slices. For example, the AMF 602 may update an indicator indicating whether alternative S-NSSAI is being used to an indicator indicating that alternative S-NSSAI is not used or delete at least one piece of information related to alternative network slices. In case that the information related to alternative network slices is stored in the UE context related to the UE, the AMF 602 may update the UE context. Alternatively, in case that the information related to alternative network slices stored in a UDM 606 or UDR, the AMF 602 may perform operations 620 to 622 to update the information related to alternative network slices. In operation 620, the AMF 602 may transmit a message to the UDM 606. The message may include the information related to alternative network slices. The UDM 606 may update the UDR with information related to the received alternative network slices.

In operation 616, the AMF 602 may transmit a UE configuration update message to the UE 600. The message may include at least one of the second Allowed NSSAI and second configured NSSAI determined by the AMF 602 in operation 614. Additionally, the AMF 602 may transmit information indicating that the alternative S-NSSAI (second S-NSSAI) is no longer used to the UE.

In operation 618, the UE 600 may store the slice information received from the AMF 602 and perform additional operations.

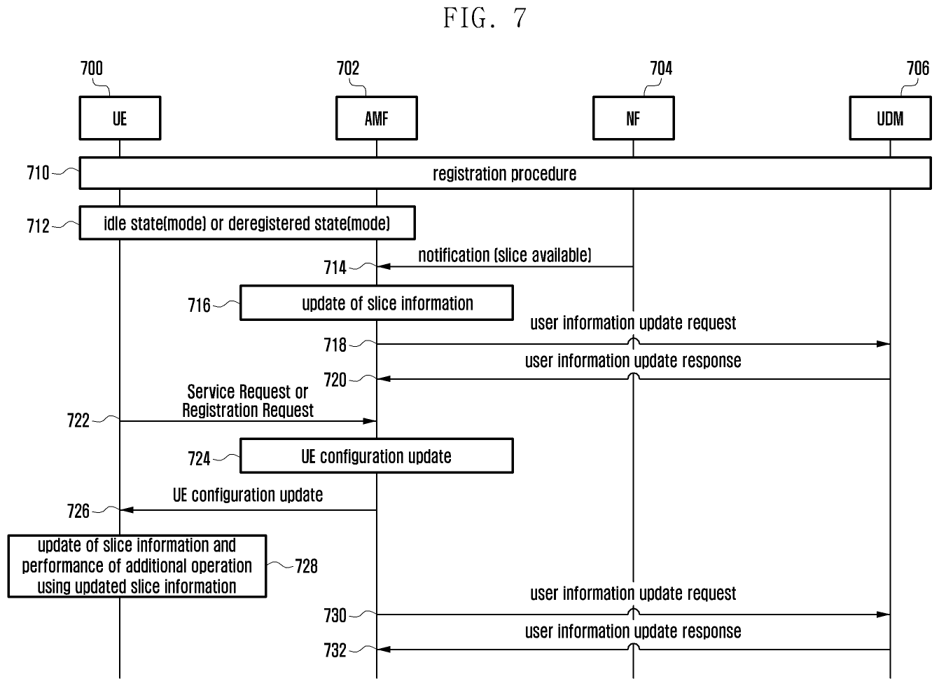

FIG. 7 is a diagram illustrating a procedure for reconfiguring existing slice information to a UE using a UE configuration update procedure in a wireless communication system according to an embodiment of the disclosure.

Referring to FIG. 7, in operation 710, a UE 700 and an AMF 702 may perform a UE registration procedure. In operation 710, the first S-NSSAI that the UE intends to use may be unavailable or congested. Accordingly, the AMF 702 may determine the second S-NSSAI, which is an alternative S-NSSAI to replace the first S-NSSAI, as the method in FIG. 4. During the registration procedure, the UE may determine the available first Allowed NSSAI, first Configured NSSAI, and Alternative NSSAI (alternative slice mapping information (mapping information of the first S-NSSAI and second S-NSSAI)) and transmit them to the UE. The first Allowed NSSAI may include at least one of the first S-NSSAI and alternative slice mapping information.

The first configured NSSAI may include at least one of the first S-NSSAI and alternative slice mapping information. The UE 700 may store the received slice information.

In operation 712, the UE 700 may change to an idle state. For example, the UE that has completed the registration process in operation 710 and is accessing the network and using the network service may not exchange signaling or data with the network for a certain period of time, and there may be no NAS signaling with the network.

Alternatively, in operation 712, the UE 700 may change to a deregistered state. For example, in operation 710, the registration process with the network may be canceled for the UE that has completed the registration process, connected to the network, and are using the network service.

In operation 712, the AMF 702 may delete the information related to alternative slices that has been stored as the UE context.

In operation 714, an NF 704 may transmit a notification message to the AMF 702. The notification message may include information indicating that the first S-NSSAI that has been unavailable or congested is available again. Operation 714 may correspond to the operation 314 in FIG. 3.

In operation 716, the AMF 702 may determine that the UE 700 using the second S-NSSAI, which is the alternative slice (alternative S-NSSAI) of the first S-NSSAI, is not currently connected to the network, that is, the UE 700 is in an idle state (UE in CM_IDLE) or deregistered state (UE in RM_DEREGISTERED). For example, the AMF 702 may not transmit UE configuration information indicating that the first S-NSSAI is available again to the UE. Accordingly, the AMF 702 may store an indicator (e.g., network slice availability change indicator, network slice alternative update indicator) indicating that the UE configuration (e.g., configured NSSAI of the UE) needs to be updated. The indicator may be an indicator indicating that UE reconfiguration is required due to a change in network slice availability (e.g., when it is necessary to delete the second S-NSSAI from configured NSSAI or Allowed NSSAI as the first S-NSSAI becomes available again or congestion in the first S-NSSAI is alleviated, or it is necessary to add the second S-NSSAI to configured NSSAI or allowed NSSAI as the first S-NSSAI becomes unavailable or the first S-NSSAI is congested).

The indicator may be stored as the UE context in the AMF 702. Alternatively, the AMF may perform operations 718 to 720 to store the indicator in the UDM or UDR. In operation 718, the AMF 702 may transmit a message to a UDM 706. In the message, the AMF 702 may include information related to an indicator indicating that the UE configuration (e.g., the UE's configured NSSAI) needs to be updated. The UDM 709 may store the received information in the UDR.

Thereafter, when the UE reconnects to the network, the AMF 702 may determine that the UE configuration information needs to be updated based on the indicator.

In operation 722, the UE 700 may reconnect to the network. Operation 722 may be accomplished through the Service Request procedure or Registration Request procedure.

During the service request procedure or registration procedure, the AMF 702 may receive UE subscription information from the UDM 706 or UDR.

In operation 724, the AMF 702 may determine that the UE configuration information needs to be updated based on the information received from the UE context or UDM/UDR. The information received from the UE context or UDM/UDR may include information related to the indicator indicating that UE configuration (e.g., UE's configured NSSAI, Allowed NSSAI, or the like) need to be updated. The AMF 702 may configure the configured NSSAI of the UE. The configured NSSAI may not include the second S-NSSAI, which is the alternative slice (alternative S-NSSAI). Additionally, the AMF 702 may configure the allowed NSSAI of the UE. Allowed NSSAI may not include the second S-NSSAI, which is the alternative slice.

In operation 726, the AMF 702 may transmit at least one of the allowed NSSAI and configured NSSAI determined in operation 724 to the UE 700. The message in operation 716 may be a registration accept message or UE configuration update message. The AMF 702 may delete an indicator indicating that the UE configuration stored as the UE context (e.g., the UE's configured NSSAI, allowed NSSAI, or the like) needs to be updated. Alternatively, the AMF 702 may perform operations 730 to 732 to delete an indicator indicating that UE configuration (e.g., UE's configured NSSAI, allowed NSSAI, or the like) needs to be updated due to network slice replacement stored in the UDM/UDR.

In operation 728, the UE may store the slice information received from the AMF and perform additional operations.

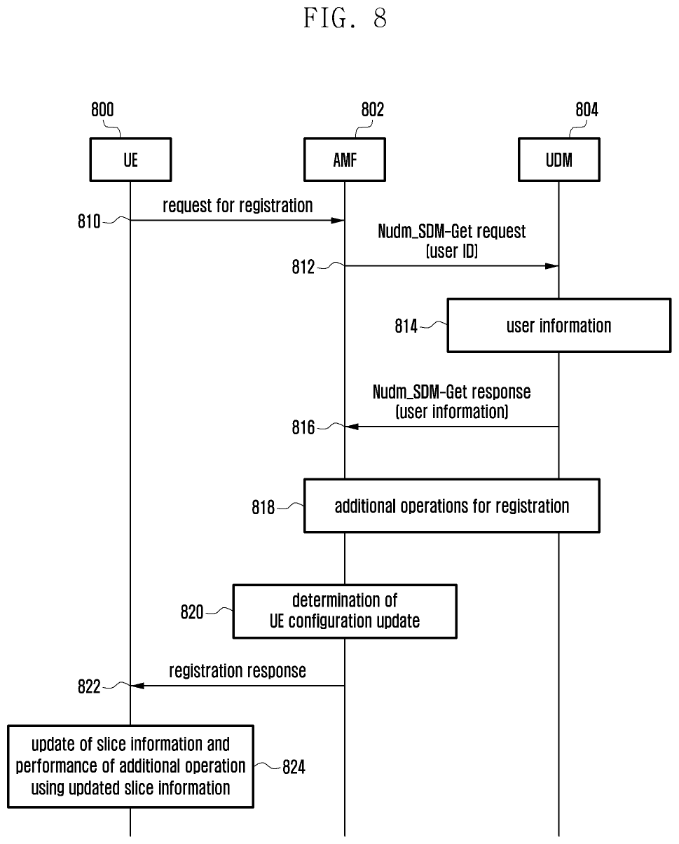

FIG. 8 is a diagram illustrating a procedure for updating UE configuration information during a registration procedure in a wireless communication system according to an embodiment of the disclosure.

Referring to FIG. 8, in operation 810, a UE 800 may perform a registration procedure.

In operation 810, the UE 800 may transmit a registration request message to an AMF 802. The registration request message may include requested slice information (requested NSSAI) that the UE intends to use. In case that the UE supports the network slice replacement function, the registration request message may include information indicating that the UE supports the network slice replacement function. If the UE stores alternative slice information (alternative NSSAI), for example, if the allowed NSSAI or configured NSSAI stored by the UE includes at least one of the alternative slice (second S-NSSAI), and mapping information of existing slice (first S-NSSAI) and alternative slice (second S-NSSAI), if the UE stores Alternative NSSAI (alternative slice mapping information), the requested NSSAI may include at least one of alternative slice information, that is, the second S-NSSAI and alternative slice mapping information. Additionally, the registration request message may include alternative NSSAI stored by the UE. The reason why the UE includes the second S-NSSAI and/or Alternative NSSAI may be because the UE has a PDU session established with the second S-NSSAI and/or first S-NSSAI.

In operation 812, the AMF 802 may process a registration request for the UE. A request message for receiving subscription information from a UDM 804 may be transmitted to the UDM 804. The request message may be a Nudm_SDM_Get request message and may include the identity of the UE (subscriber).

In operation 814, the UDM 804 may generate a response including subscription information of the UE (subscriber) according to the AMF's request. A response message including UE subscription information may include subscription slice (subscribed S-NSSAI) information of the UE.

In operation 816, the UDM 804 may transmit the subscription information of the UE (subscriber) as a response message to the AMF 802. The response message may be a Nudm_SDM_Get response message.

In operation 818, other operations for registration may be performed.

In operation 820, the AMF 802 may determine allowed NSSAI. The requested NSSAI transmitted by the UE in operation 810 may include the second S-NSSAI (alternative S-NSSAI). The second S-NSSAI may be an unsubscribed network slice. The unsubscribed network slice may mean a network slice (S-NSSAI) that is not included in the subscribed network slices (subscribed S-NSSAIs) stored in the UDM 804. In other words, the network (AMF, UDM, or the like) may include a network slice that the UE has not subscribed in the allowed NSSAI and/or configured NSSAI, and transmit the same to the UE, and the UE may configure the requested NSSAI based on the received allowed NSSAI and/or configured NSSAI. Through this, network slice replacement functionality may be provided in situations where a specific S-NSSAI is unavailable or congested. In other words, an alternative S-NSSAI to replace a specific S-NSSAI may be temporarily used. The AMF 802 may verify the requested NSSAI (validity of requested NSSAI) based on at least one of subscribed S-NSSAIs and alternative network slice information. Subscribed S-NSSAI may be the information received by the AMF 802 from the UDM 804. The replacement network slice information may be the information stored by the AMF 802 as a UE context, information stored by the AMF 802 as a local configuration, and information received by the AMF 802 from the UDM 804 or UDR. Additionally, the alternative network slice information may include at least one of the alternative slice (second S-NSSAI) and alternative slice mapping information (mapping information of the first S-NSSAI and second S-NSSAI). Among the S-NSSAIs included in the requested NSSAI, the network slice to which the UE subscribes may be included in the subscribed S-NSSAIs and may be verified based on this. Among the S-NSSAIs included in the requested NSSAI, the unsubscribed alternative S-NSSAI is not included in the subscribed S-NSSAIs, and the unsubscribed alternative S-NSSAI may be included in the alternative network slice information and may be verified based on this. In case that the requested NSSAI is not valid, that is, in case that one or more S-NSSAIs included in the requested NSSAI are not included in the subscribed S-NSSAIs and are not included in the alternative network slice information, the AMF 802 may determine that the UE configuration information is not valid and determine to update the UE configurations. The AMF 802 may determine the allowed NSSAI based on at least one of requested NSSAIs, subscribed S-NSSAIs, alternative network slice information, and network slice information supported at the current location received in operation 810. The AMF 802 may determine to reject an S-NSSAI that is not included in the subscribed S-NSSAIs and is not included in the alternative network slice information among the S-NSSAIs included in the requested NSSAI. In this case, the AMF 802 may provide the S-NSSAI to the UE as rejected S-NSSAIs. Rejected S-NSSAI may be included in the registration response message in operation 822 and transmitted to the UE.

In operation 820, the AMF 802 may identify that the requested NSSAI transmitted by the UE includes an alternative S-NSSAI (second S-NSSAI). Alternatively, the AMF 802 may identify that the registration request message received in operation 810 includes Alternative NSSAI. Additionally, the AMF 802 may use the first S-NSSAI based on at least one of the notification message received from the NF, information received from the OAM, and configuration information (local configuration) stored in the AMF. Accordingly, it may be determined that the use of the second S-NSSAI is unnecessary. Accordingly, the AMF may determine that the UE configuration information stored by the UE is not up to date. For example, the AMF 802 may determine to delete the second S-NSSAI from the UE configuration information. The AMF may configure a new configured NSSAI. Configured NSSAI may not include the second S-NSSAI. Additionally, since the use of the second S-NSSAI requested by the UE 800 is unnecessary, the AMF 802 may not include the second S-NSSAI in Allowed NSSAI.

In operation 822, the AMF 802 may transmit a registration response message to the UE 800. The registration response message may include at least one of configured NSSAI and allowed NSSAI.

In operation 824, the UE 800 may store the slice information received from the AMF 802 and perform additional operations.

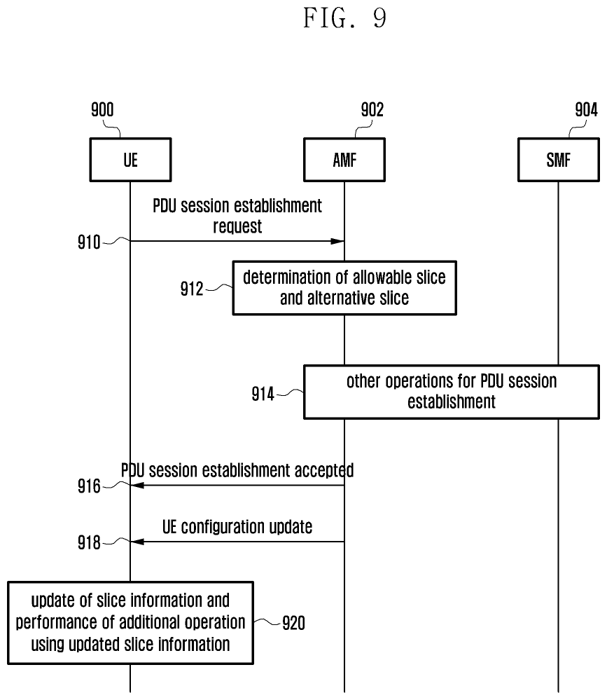

FIG. 9 is a diagram illustrating a new PDU session establishment procedure in a wireless communication system according to an embodiment of the disclosure.

Referring to FIG. 9, in operation 910, a UE 900 may determine to establish a PDU session to use the application (App1) based on at least one of Allowed NSSAI, Alternative NSSAI, and UE route selection policy (URSP). The UE 900 may determine that the network slice for using the application (App1) is the first S-NSSAI, based on the URSP. The UE 900 may determine that the first S-NSSAI is an available network slice based on Allowed NSSAI. The UE 900 may determine that the second S-NSSAI is used as an alternative S-NSSAI in place of the first S-NSSAI, based on Alternative NSSAI. The UE 900 may configure a PDU session establishment request message for using the application (App1). The PDU session establishment request message may include at least one of a PDU session ID, first S-NSSAI, and second S-NSSAI. The UE 900 may transmit a PDU session establishment request message to an AMF 902.

In operation 912, the AMF 902 may process the UE's PDU session establishment request message. The AMF 902 may identify whether the mapping between the first S-NSSAI and the second S-NSSAI replacing the first S-NSSAI is correct. For example, the AMF 902 may identify whether the second S-NSSAI is being used to replace the first S-NSSAI based on alternative NSSAI information stored in AMF, UDM, or UDR. If the second S-NSSAI is not being used to replace the first S-NSSAI, that is, in case that the information transmitted by the UE in operation 910 is incorrect, or the second S-NSSAI (in the corresponding PLMN) is not valid, the AMF 902 may determine that the UE's configuration information needs to be updated. The AMF 902 may determine an alternative S-NSSAI (third S-NSSAI) to replace the first S-NSSAI using the method described in various embodiments of the disclosure, and determine allowed NSSAI, alternative NSSAI, and configured NSSAI. Alternatively, the AMF 902 may determine that the first S-NSSAI is currently available using the method described in various embodiments of the disclosure, and determine allowed NSSAI and configured NSSAI accordingly.

In operation 914, the AMF 902 may process the UE's PDU session establishment request. The AMF 902 may perform a PDU session establishment procedure using the alternative S-NSSAI (third S-NSSAI) determined by the AMF in operation 912. In this case, the AMF 902 may transmit the first S-NSSAI and third S-NSSAI to an SMF 904. Alternatively, in case that the first S-NSSAI is available, the AMF 902 may perform a PDU session establishment procedure using the first S-NSSAI. In this case, the AMF 902 may transmit the first S-NSSAI to the SMF 904.

In operation 916, the AMF 902 may transmit a PDU session establishment accept message to the UE 900. The PDU session establishment accept message may include at least one of a PDU session ID and first S-NSSAI, and the alternative S-NSSAI (third S-NSSAI) determined by the AMF. Alternatively, in case that the first S-NSSAI is available, the PDU session establishment accept message may include the PDU session ID and first S-NSSAI.

In operation 918, the AMF 902 may transmit to the UE 900 the UE configuration update message including at least one of allowed NSSAI, alternative NSSAI, and configured NSSAI determined in operation 912.

The AMF 902 may perform operation 916 first and then perform operation 918. Alternatively, the AMF 902 may perform operation 918 first and then perform operation 916. For example, operations 916 and 918 may occur independently regardless of order.

In operation 920, the UE 900 may store the information received in operations 916 and 918.

In case that the AMF 902 determines to use the third S-NSSAI in place of the first S-NSSAI, the UE 900 may know that the third S-NSSAI is used instead of the first S-NSSAI, based on the received information. Additionally, the UE 900 may know that a PDU session has been established using the third S-NSSAI instead of the first S-NSSAI.

In case that the AMF 902 determines to use the first S-NSSAI, the UE 900 may know that the first S-NSSAI is available based on the received information. Additionally, the UE 900 may know that a PDU session has been established using the first S-NSSAI.

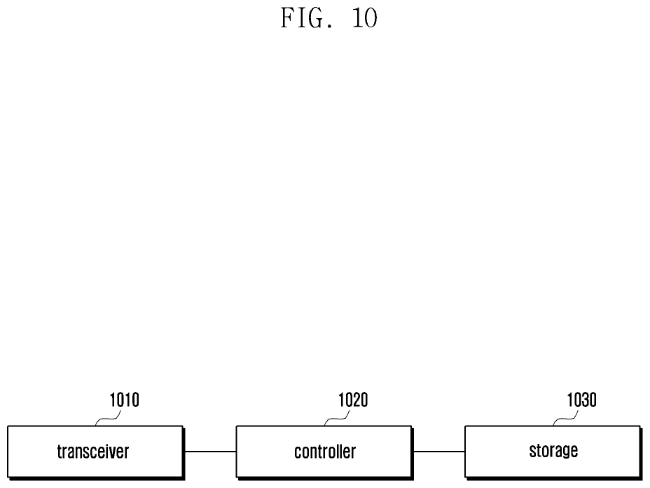

FIG. 10 is a diagram illustrating a structure of a UE according to an embodiment of the disclosure.

Referring to FIG. 10, the UE may include a transceiver 1010, a controller 1020, and a storage 1030. In the disclosure, the controller may be defined as a circuit, an application-specific integrated circuit, and at least one processor.

The transceiver 1010 may transmit and receive a signal to/from another network entity. For example, the transceiver 1010 may receive, from a base station, system information, and a synchronization signal or a reference signal.

The controller 1020 may control general operations of the network entity according to embodiments proposed in the disclosure. For example, the controller 1020 may control a signal flow between blocks to perform operations described with reference to the flowchart.

The storage 1030 may store at least one of information transmitted and received through the transceiver 1010 or information generated by the controller 1020.

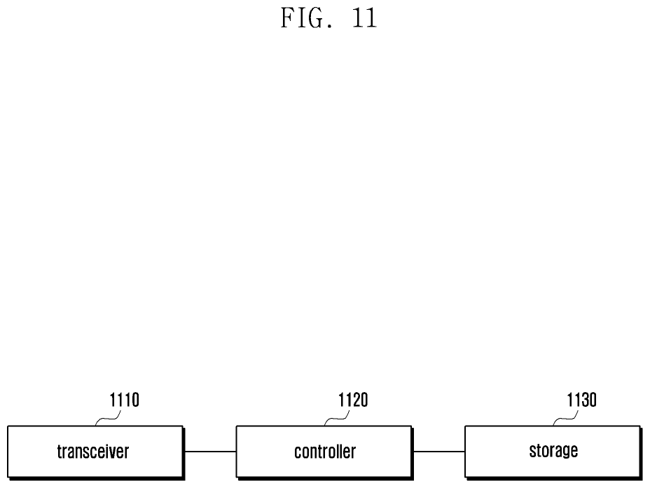

FIG. 11 is a diagram illustrating a structure of a network entity according to an embodiment of the disclosure.

Referring to FIG. 11, the network entity may include a transceiver 1110, a controller 1120, and a storage 1130. In the disclosure, the controller may be defined as a circuit, an application-specific integrated circuit, and at least one processor.

The transceiver 1110 may transmit and receive a signal to/from another network entity.

The controller 1120 may control general operations of the network entity according to embodiments proposed in the disclosure. For example, the controller 1120 may control a signal flow between blocks to perform operations described with reference to the flowchart.

The storage 1130 may store at least one of information transmitted and received through the transceiver 1110 or information generated by the controller 1120.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an access and mobility management function (AMF) in a wireless communication system, the method comprising:
receiving, from a user equipment (UE), a requested network slice selection assistance information (NSSAI);
receiving, from a unified data management (UDM), a subscribed single-NSSAI (S-NSSAI);
determining whether an S-NSSAI in the requested NSSAI is either the subscribed S-NSSAI or an alternative S-NSSAI in a UE context; and
determining whether to update a UE configuration in case that the S-NSSAI in the requested NSSAI is neither the subscribed S-NSSAI nor the alternative S-NSSAI in the UE context.

2. The method of claim 1, further comprising:
storing information on mapping of the S-NSSAI to the alternative S-NSSAI in the UE context.

3. The method of claim 1, further comprising:
transmitting, to the UE, a UE configuration update message for updating a UE configuration based on the determination.

4. The method of claim 1, further comprising:
transmitting, to the UE, a message including information on mapping of the S-NSSAI to the alternative S-NSSAI to the UE, in case that the S-NSSAI in the requested NSSAI is the alternative S-NSSAI in the UE context,
wherein the message is a UE configuration update message or a registration accept message.

5. The method of claim 1, further comprising:
transmitting, to the UE, a registration accept message including an allow NSSAI in case that in case that the S-NSSAI in the requested NSSAI is either the subscribed S-NSSAI or the alternative S-NSSAI in the UE context.

6. A method performed by a user equipment (UE) in a wireless communication system, the method comprising:
transmitting, to an access and mobility management function (AMF), a requested network slice selection assistance information (NSSAI),
wherein a subscribed single-NSSAI (S-NSSAI) is transmitted from a unified data management (UDM) to the AMF,
wherein whether an S-NSSAI in the requested NSSAI is either the subscribed S-NSSAI or an alternative S-NSSAI in a UE context is determined, and
wherein whether to update a UE configuration is determined in case that the S-NSSAI in the requested NSSAI is neither subscribed S-NSSAI nor alternative S-NSSAI in the UE context.

7. The method of claim 6, further comprising:
configuring information on mapping of the S-NSSAI to the alternative S-NSSAI in the UE context.

8. The method of claim 6, further comprising:
receiving, from the AMF, a UE configuration update message for updating a UE configuration based on the determination.

9. The method of claim 6, further comprising:
receiving, from the AMF, a message including information on mapping of the S-NSSAI to the alternative S-NSSAI to the UE, in case that the S-NSSAI in the requested NSSAI is the alternative S-NSSAI in the UE context,
wherein the message is a UE configuration update message or a registration accept message.

10. The method of claim 6, further comprising:
receiving, from the AMF, a registration accept message including an allow NSSAI in case that in case that the S-NSSAI in the requested NSSAI is either the subscribed S-NSSAI or the alternative S-NSSAI in the UE context.

11. An access and mobility management function (AMF) in a wireless communication system, the AMF comprising:
a transceiver; and
a controller operably connected to the transceiver, the controller configured to:
receive, from a user equipment (UE), a requested network slice selection assistance information (NSSAI),
receive, from a unified data management (UDM), a subscribed single-NSSAI (S-NSSAI),
determine whether an S-NSSAI in the requested NSSAI is either the subscribed S-NSSAI or an alternative S-NSSAI in a UE context, and
determine whether to update a UE configuration in case that the S-NSSAI in the requested NSSAI is neither the subscribed S-NSSAI nor the alternative S-NSSAI in the UE context.

12. The AMF of claim 11, wherein the controller is further configured to:
store information on mapping of the S-NSSAI to the alternative S-NSSAI in the UE context.

13. The AMF of claim 11, wherein the controller is further configured to:
transmit, to the UE, a UE configuration update message for updating a UE configuration based on the determination.

14. The AMF of claim 11,
wherein the controller is further configured to:
transmit, to the UE, a message including information on mapping of the S-NSSAI to the alternative S-NSSAI to the UE, in case that the S-NSSAI in the requested NSSAI is the alternative S-NSSAI in the UE context, and
wherein the message is a UE Configuration Update message or a registration accept message.

15. The AMF of claim 11, wherein the controller is further configured to:
transmit, to the UE, a registration accept message including an allow NSSAI in case that in case that the S-NSSAI in the requested NSSAI is either the subscribed S-NSSAI or the alternative S-NSSAI in the UE context.

16. A user equipment (UE) in a wireless communication system, the UE comprising:
a transceiver; and
a controller operably connected to the transceiver, the controller configured to:
transmit, to an access and mobility management function (AMF), a requested network slice selection assistance information (NSSAI),
wherein a subscribed single-NSSAI (S-NSSAI) is transmitted from a unified data management (UDM) to the AMF,
wherein whether an S-NSSAI in the requested NSSAI is either the subscribed S-NSSAI or an alternative S-NSSAI in a UE context is determined, and
wherein whether to update a UE configuration is determined in case that the S-NSSAI in the requested NSSAI is neither subscribed S-NSSAI nor alternative S-NSSAI in the UE context.

17. The UE of claim 16, wherein the controller is further configured to:
configure information on mapping of the S-NSSAI to the alternative S-NSSAI in the UE context.

18. The UE of claim 16, wherein the controller is further configured to:
receive, from the AMF, a UE configuration update message for updating a UE configuration based on the determination.

19. The UE of claim 16,
wherein the controller is further configured to:
receive, from the AMF, a message including information on mapping of the S-NSSAI to the alternative S-NSSAI to the UE, in case that the S-NSSAI in the requested NSSAI is the alternative S-NSSAI in the UE context, and
wherein the message is a UE configuration update message or a registration accept message.

20. The UE of claim 16, wherein the controller is further configured to:
receive, from the AMF, a registration accept message including an allow NSSAI in case that in case that the S-NSSAI in the requested NSSAI is either the subscribed S-NSSAI or the alternative S-NSSAI in the UE context.
